(19) United States
(12) Patent Application Publication
(10) Pub. No.: US 2026/0222659 A1
(43) Pub. Date: Jul. 30, 2026

(54) AI-ENABLED SYSTEMS AND METHODS FOR AUTOMATED NEWSCAST PRODUCTION

(71) Applicant: Clarity Patton, Livonia, MI (US)

(72) Inventors: Clarity Patton, Pickney, MI (US); Mark J. McDowell, Pickney, MI (US); Robert C. Young, O'Fallon, MO (US)

(73) Assignee: Clarity Patton, Livonia, MI (US)

(21) Appl. No.: 19/459,317

(22) Filed: Jan. 26, 2026

Related U.S. Application Data
(60) Provisional application No. 63/750,001, filed on Jan. 27, 2025.

(51) Int. Cl. H04N 21/85; G06F 16/958; G06T 13/40; G10L 13/00

(52) U.S. Cl. CPC H04N 21/85; G06F 16/958; G06T 13/40; G10L 13/00

(57) ABSTRACT

Presented are systems and methods for automating newscast production using artificial intelligence-driven computational techniques. Disclosed systems may integrate Natural Language Processing (NLP), AI-driven voice synthesis, and automated video composition tools into a unified workflow that autonomously extracts news articles, images, and multimedia from digital platforms. Using this extracted digital media, the system automatically curates relevant content using advanced algorithms and transforms the curated content into professional-grade video newscasts. Lifelike AI avatar anchors deliver these newscasts with natural speech patterns and synchronized movements. The system may also support real-time updates for breaking news and may enable monetization through targeted advertisements before, during, or after video content. Designed for scalability and cost-efficiency, this technology may provide local news organizations with an innovative solution to produce engaging multimedia content efficiently while modernizing their digital offerings. Disclosed systems and methods have potential applications in other industries, such as corporate training videos and educational modules.

### CLAIM OF PRIORITY AND CROSS-REFERENCE TO RELATED APPLICATION

This application claims the benefit of and priority to U.S. Provisional Patent Application No. 63/750,001 , which was filed on Jan. 27, 2025, and is incorporated herein by reference in its entirety and for all purposes.

### INTRODUCTION

The present disclosure relates generally to artificial intelligence (AI) driven distributed computing systems. Specific aspects of this disclosure may relate to Artificial Narrow Intelligence (ANI) systems for creating digital content for mass distribution.

The local news publishing industry faces significant challenges in competing with television newscasts due to high costs and logistical barriers associated with producing professional-grade video content. Traditional approaches to producing local newscasts require substantial investments in specialized equipment, skilled staff, and time-intensive workflows, making them impractical for resource-constrained local news organizations. Despite advancements in related technologies, conventional systems have not successfully addressed these challenges by providing an integrated workflow tailored specifically to local news production. Existing solutions focus on isolated tasks, such as automated transcription or data analysis, rather than offering a comprehensive approach. For example, REUTERS NEWS TRACER® aggregates social media data but does not transform written articles into multimedia formats. Similarly, AI Studios by DEEPBRAIN® AI offers video generation tools but lacks end-to-end integration needed by local news organizations.

### SUMMARY

Presented below are generative AI-enabled distributed computing systems for automating the creation of digital media for news broadcasts, methods for customizing and methods for utilizing such AI-enabled systems, and memory-stored, computer-readable code for provisioning such generative-AI platforms. By way of non-limiting example, an innovative process and computing platform produces local newscasts using AI-assisted technology to automate the creation of engaging multimedia newscasts by sourcing stories and images from mass media and newspaper websites. The AI system may autonomously compile, curate, and format content into polished video newscasts, complete with professional graphics and animations, enhancing the visual and interactive experience for viewers. By automating content curation, formatting, and video production, disclosed systems and processes may help to reduce costs, improve efficiency, and expand audience engagement through multimedia platforms. Disclosed systems and processes may also provide a scalable, efficient, and cost-effective solution for delivering high-quality video news presentations via digital platforms.

AI-assisted newscast production systems and methods enable local news organizations to produce and publish AI-driven video news stories and full newscasts online. AI-enabled avatar engines generate AI avatars with synthesized voices to present local news content in a lifelike manner. Content compilation engines automatically compile stories, images, and relevant multimedia elements sourced from websites and format them into professional-grade newscasts. These AI-generated newscasts may incorporate on-screen graphics and animations, photos and video clips (when available), graphic supers (superimposed text), and other visual and audio elements which may simulate the aesthetics of traditional television newscasts. Flexible video story creation may be enabled by converting individual news articles into standalone, AI-hosted video stories that can be accessed independently.

Disclosed generative artificial intelligence (AI) features may include an AI engine whose primary function is to generate content, such as for translating speech from a natural (origin) form to a designated (target) form or for producing text from prompted text-based inputs of a user. Other AI-driven engines may include those that perform select functions, such as classifying data (e.g., evaluating and labelling digital images), grouping data (e.g., processing and identifying data segments with similar behaviors), or determining actions (e.g., governing dynamic movements of an AI avatar). Some non-limiting examples of generative AI computing platforms include image generators, large language models, code generation tools, and audio generation tools. While unable to comprehend and apply information like a human, Artificial Narrow Intelligence (ANI) constructs may employ a variety of different generative AI models, functioning within a fixed and predefined set of parameters and settings, to execute a primary task or a designated set of interrelated tasks.

Disclosed systems and methods may automate every step of newscast production through a unified workflow, including integration with a publisher's existing news CMS. By addressing longstanding challenges, disclosed systems and methods may provide a scalable solution that empowers organizations to modernize their offerings, attract new audiences, and maintain relevance in an increasingly multimedia-driven media landscape. Scalability of content production engenders increased efficiency and cost-effectiveness without requiring additional expertise or infrastructure.

This is a marked improvement to existing technology, for example, by improving the efficiency and efficacy of: (1) capturing news information from a vast array of discrete news sources, (2) filtering, correlating, evaluating, and selectively extracting specific content from the captured information; (3) converting the captured information to create a new type of media format, (4) creating a converted digital file for the newly created media, and (5) streamlining the mass dissemination of such media. Synchronization of discrete news sources along with automated animation of resultant video newscasts offer improvements in attendant computer-related technology. In addition to providing a comprehensive approach to producing local newscasts and reducing end-user costs, this arrangement may also help to reduce computational load, minimize total processing resources, and reduce server memory usage.

Aspects of this disclosure are directed to systems for AI-assisted production of video newscasts. For example, a system may include an AI-based story engine that extracts and compiles text-based news stories from digital platforms, and an AI-based avatar engine that generates a digital avatar with voice synthesis capabilities to deliver the compiled content as video news presentations. The system may also include automated tools for adding visual and audio elements, including on-screen graphics, animations, photos, video clips, and superimposed text. A video composition module may be employed to format and assemble content into polished video newscasts, and a web integration module may be employed to host and publish video newscasts online (e.g., on an organization's website). The AI-based story engine may include a Natural Language Processing (NLP) module for comprehension and extraction of news stories, and a web scraping module to source stories, images, and multimedia elements. The AI-based avatar engine may include an advanced voice synthesis module for mimicking human-like speech for delivering video news stories. The system may have a scalable architecture that is capable of supporting multiple news organizations and varying content volumes. Individual news articles may be automatically converted into standalone video stories that may be presented by AI-driven avatars. The system may generate on-screen content, such as animations, graphics, photos, video clips, and superimposed text elements.

Additional aspects of this disclosure are directed to methods for AI-assisted production and distribution of news and media content. A method may include, for example: collecting text-based news content from a digital platform; analyzing the collected news content; extracting, from the analyzed news content, one or more “relevant” stories using Natural Language Processing; generating one or more AI avatars with voice synthesis technology to present the extracted one or more stories; formatting the extracted one or more stories into one or more video news presentations by integrating animations, photos, supers, and video clips; and automatically publishing the one or more video news presentations to a host platform for audience distribution. In the above method, the NLP may identify story relevance, headlines, and/or supporting multimedia content. In the above method, the AI avatars may replicate human-like speech patterns and facial movements for news delivery. In the above method, the video formatting module may automate the addition of graphics, transitions, and superimposed text, and may simulate the appearance of traditional TV broadcasts. In the above method, video content may be seamlessly embedded into a digital platform or website using standard web technologies. In the above method, the system may support multiple news organizations and may scale based on content volume. In the above method, individual text-based news articles may be converted into standalone, AI-avatar video stories. In the above method, the system may periodically update video content to reflect real-time news stories.

Aspects of this disclosure may also be directed to methods for collecting, compiling, and disseminating news content. In an example, a method may include: collecting text-based news articles, images, and/or videos from a news website or a Content Management System (CMS); analyzing, using an NLP model, the collected content to identify and curate one or more “relevant” stories; and automatically transferring and embedding the one or more stories on a host organization's website and/or digital platform. The method may also include optimizing video indexing for search engine and audience discoverability using metadata tags. The method may also include generating AI avatars with lifelike speech synthesis technology to deliver one or more curated stories. Each avatar may be programmed to replicate natural human speech patterns for professional news delivery. The method may also include integrating on-screen graphics, animations, photos, supers, and/or video clips to assemble video newscasts and individual news story presentations. Editing tools may automate the composition, transitions, and timing for a professional broadcast appearance. The method may also include scaling system output to accommodate multiple news organizations and varying content volumes. Periodic updates may help to ensure timely news delivery and relevancy.

Aspects of this disclosure are also directed to methods of controlling newscast production systems for automating the creation of video newscasts. In an example, a representative method includes, in any order and in any combination with any of the above and below disclosed options and features: importing, e.g., via an article parsing engine of the newscast production system over a distributed computing network, news content data from a dispersed array of distinct data sources; organizing, e.g., via a story creation engine of the newscast production system, the news content data into story rundowns (i.e., story rundowns) stored in a system memory device; generating, e.g., via a story processing engine of the newscast production system using an Artificial Narrow Intelligence module, a respective video newscast package narrated by a digital avatar anchor for each of multiple story segments correlated with the story rundowns; merging, e.g., via a newscast processing engine of the newscast production system according to a predefined newscast rundown, the video newscast packages of the story segments into a unified newscast program stored in the system memory device; and publishing, e.g., via a newscast publishing engine of the newscast production system over the distributed computing network, the unified newscast program on a dispersed array of distinct websites.

Further aspects of this disclosure are directed to newscast production systems with attendant control logic for automating production of video newscasts. In an example, a newscast production system includes an article parsing engine that communicatively connects to a distributed computing network and, when connected, imports news content data from a dispersed array of distinct data sources. Communicatively connected to the article parsing engine is a story creation engine that organizes the imported news content data into story rundowns that are stored in a system memory device. A story processing engine, which is communicatively connected to the story creation engine, uses an ANI module to generate a respective video newscast package narrated by a digital avatar anchor for each story segment correlated with one of the story rundowns. Communicatively connected to the story processing engine is a newscast processing engine that merges the video newscast packages into a unified newscast program according to a predefined newscast rundown; this unified newscast program is stored in the system memory device. A newscast publishing engine, which is communicatively connected to the newscast processing engine, publishes the unified newscast program on a dispersed array of distinct websites on the distributed computing network.

For any of the herein described systems, methods, and computer-readable media (CRM), importing news content may include determining if an import content trigger has occurred (e.g., time-based or event-based trigger); in response to the trigger occurring, the article parsing engine determines a preset parsing window (e.g., 12-hour window, 24-hour window, etc.) and restricts importing of new content to that preset parsing window. As a further option, importing news content may include locating and retrieving news content data from a dispersed array of distinct data sources and then filtering the retrieved news content data. In this instance, importing news content may also include validating the filtered news content data and, once validated, downloading image previews for the validated news content data.

For any of the herein described systems, methods, and CRM, organizing imported news content data may include categorizing the story rundowns according to a set of predefined newscast rundown types, including automatic newscast rundowns and feature story rundowns. An automatic newscast rundown may automate the selection of news stories to include in a newscast, the order in which the stories are arranged, the emotional tone for reading each story, the incorporation of commercials, and the insertion of additional content for producing a video newscast, whereas a feature story rundown may include the manual selection of stories to be used in feature story videos. As a further option, organizing imported news content data may include determining a nearest-in-time newscast deadline, which includes an air date and an airtime, and then ordering the story segments by the air date (date/time) and then by the airtime (duration). Organizing imported news content data may also include determining a criteria ruleset for the video newscast (e.g., belongs to new source organization, not deleted, has valid status, etc.), and calculating a current newscast duration for the video newscast. A subset of the ordered story rundowns is then selected based on the criteria ruleset and the calculated duration of the video newscast. A package is a video produced from a news story that will be used as a segment of a newscast.

For any of the herein described systems, methods, and CRM, generating a respective video newscast package for a story segment may include: mapping text within correlated story rundowns to the story segment using a Large Language Model (LLM)-powered audio generation project format; selecting a digital avatar anchor for the story segment based on one or more emotion criteria and/or one or more category criteria; composing an anchor script with anchor clips for the digital avatar anchor; and generating, using an LLM-audio generator, an anchor audio file for the digital avatar anchor based on the anchor script. As a further option, generating a respective video newscast package for a story segment may include: processing text data and image data within the story rundowns that are correlated to the story segment; calculating image and video dimensions for the story segment; creating image/video entities with order keys for the story segment; and storing the processed text and image data, calculated image and video dimensions, and the image/video entities with order keys to a storage file stored in the system memory device. Generating a respective video newscast package for a story segment may also include: mapping images within the story rundowns correlated to the story segment using an LLM-powered video generation project format; generating a scene configuration and background image/video content for the video newscast package; composing an anchor animation sequence for the digital avatar anchor; and generating an anchor video file for the digital avatar anchor using an LLM-video generator.

For any of the herein described systems, methods, and CRM, merging multiple video newscast packages into a unified newscast program may include determining when the video newscast packages for the story segments that are allocated by the predefined newscast rundown to the unified newscast program are finished. The finished video newscast packages are then sequenced into a newscast video in accordance with a newscast sequence set forth in the predefined newscast rundown, and the sequenced video newscast packages are united into a single video file, referred to herein as a unified newscast program. Merging multiple video newscast packages into a unified newscast program may also include generating opening and closing video segments that are customized for the unified newscast program, and combining the opening and closing video segments into the unified newscast program.

For any of the herein described systems, methods, and CRM, publishing a unified newscast program may include creating an episode identifier, which includes a newscast source entity or a feature story entity for the unified newscast program, and an air date attribute for the unified newscast program. Once created, the episode identifier and the air date attribute are then assigned to the unified newscast program stored in the system memory device. Publishing a unified newscast program may also include adding a video library interface, which includes a set of playback controls for selectively displaying the unified newscast program on a given website, and concurrently adding a download control to the video library interface for initiating transfer of the unified newscast program to a local storage device of a user.

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and the appended claims. Moreover, this disclosure expressly includes any and all combinations and subcombinations of the elements and features presented above and below.

### BRIEF DESCRIPTION OF THE DRAWINGS

FIG. 1 is a diagrammatic illustration of a representative AI-driven system and attendant control logic for automating newscast production in accord with aspects of the present disclosure.

FIG. 2 is a diagrammatic illustration of a representative AI-driven news delivery module and attendant control logic for facilitating newscast production in accord with aspects of the present disclosure.

FIG. 3 is a flowchart illustrating a representative newscast production system control protocol for automating video newscast production, which may correspond to non-transient, memory-stored instructions that are executable by a resident or remote microprocessor, control module, programmable logic device, central controller, or other integrated circuit device or network of processors/controllers/modules/circuits/devices/etc. (collectively “controller”) in accord with aspects of the present disclosure.

FIG. 4 is a flowchart illustrating the article parsing engine of the representative newscast production system and control protocol of FIG. 3.

FIG. 5 is a flowchart illustrating the story creation engine and newscast filling engine of the representative newscast production system and control protocol of FIG. 3.

FIG. 6 is a flowchart illustrating the story processing engine of the representative newscast production system and control protocol of FIG. 3.

FIG. 7 is a flowchart illustrating the video merging engine of the representative newscast production system and control protocol of FIG. 3.

FIG. 8 is a flowchart illustrating the newscast publishing engine of the representative newscast production system control protocol of FIG. 3.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Brief Description of the Drawings, and Detailed Description sections, but not explicitly set forth in the claims, should not be incorporated into the claims, singly or collectively, by implication, inference or otherwise. Moreover, recitation of “first”, “second”, “third”, etc., in the specification or claims is not per se used to establish a serial or numerical limitation; unless specifically stated otherwise, these designations may be used for ease of reference to similar features in the specification and drawings and to demarcate between similar elements in the claims.

For purposes of this disclosure, unless specifically disclaimed: the singular includes the plural and vice versa (e.g., indefinite articles “a” and “an” should generally be construed as meaning “one or more”); the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at, near, or nearly at,” or “within 0-5% of,” or “exactly or reasonably close to,” or any logical combination thereof, for example.

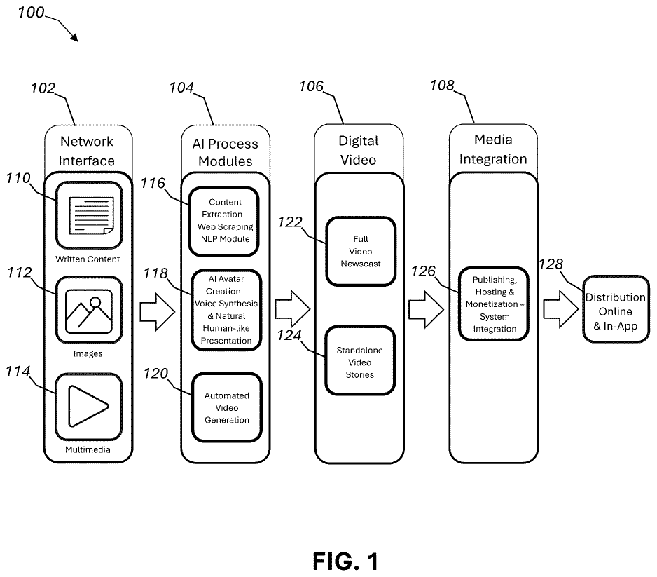

Referring now to the drawings, wherein like reference numbers refer to like features throughout the several views, there is shown in FIG. 1 a representative AI-driven distributed computing system and method 100 for automating the creation of digital media for news broadcasts. The illustrated AI-driven distributed computing system 100—also referred to herein as “newscast production system” or “system” for short—is merely an exemplary application with which aspects of this disclosure may be practiced. In the same vein, utilization of the present concepts for creating news broadcast videos should also be appreciated as a non-limiting application of disclosed features. As such, it will be understood that novel aspects of this disclosure may be utilized for creating a variety of different types of digital media and may be incorporated into any logically relevant type of AI-driven computing system. Moreover, only select components of the computing system are shown and described in detail below. Nevertheless, the systems discussed herein may include numerous additional and alternative features, and other available peripheral hardware, for carrying out the various methods and functions of this disclosure.

In accord with the illustrated example, the computing system 100 of FIG. 1 includes a Network Communication Interface 102 that communicates, e.g., over a distributed computing network, with one or more data sources, such as a Written Content data source 110, a Digital Image data source 112, and a Multimedia data source 114. Data collected from these various sources may be input to a set of interoperable AI-driven Process Modules 104, which may include a Content Extraction module 116, an AI Avatar module 118, and an Automated Video Generation (AVG) module 120. The Content Extraction module 116 may contain a Natural Language Processing (NLP) subroutine for comprehension and extraction of news stories, and a web scraping subroutine to source stories, images, and multimedia elements. The AI Avatar module 118 may generate a digital avatar with voice synthesis capabilities and human-like attributes to deliver the compiled content as a video newscast. The AVG module 120 may contain automated AI-driven tools to generate a video newscast and add visual and audio elements, including on-screen graphics, animations, photos, video clips, and superimposed text.

With continuing reference to FIG. 1, the AI-driven Process Modules 104 may output the video newscast and corresponding digital avatar as Digital Video Content 106, which may be specifically tailored to a local news organization or may be formatted more generally for mass distribution across national and international media outlets. For instance, the Digital Video Content 106 may be in the form of a full video newscast 122 which contains content that mimics traditional TV newscasts through on-screen animations, graphics, photos, video clips, and superimposed text elements. As a further option, the Digital Video Content 106 may be automatically converted into one or more Standalone Video Stories 124 that may be curated to a specific demographic and/or specific standards associated with a regional news outlet. A Media Integration Module 108 may contain a Publishing, Hosting & Monetization subroutine 126 that provides system integration for the formatted video newscast and standalone video stories output as the Digital Video Content 106. An Online & In-App Distribution module 128 may broadcast the integrated and formatted video newscast output at 108.

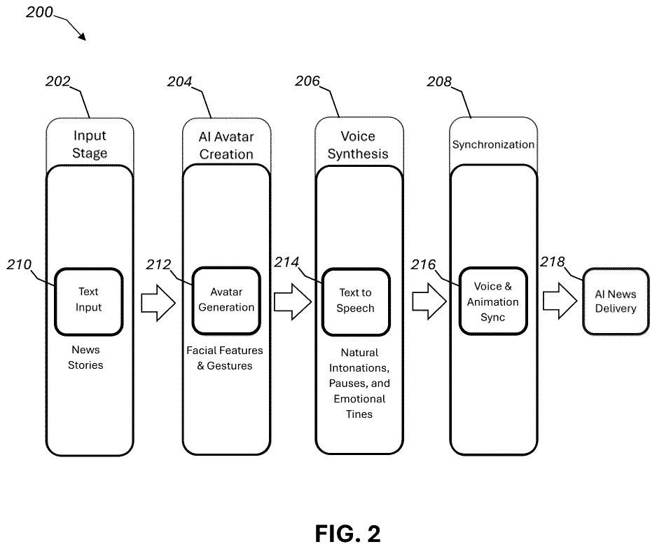

Turning next to FIG. 2, there is shown a representative AI-driven News Production and Delivery (NPD) module 200 for facilitating the creation and dissemination of digital media for news broadcasts. The NPD module 200 may be typified by four interoperable software subroutines: an Input Stage subroutine 202, an AI Avatar Creation subroutine 204, a Voice Synthesis subroutine 206, and a Video Synchronization subroutine 208. The Input Stage subroutine 202 contains a Text Input protocol 210 that locates, collects, filters, and analyzes digital news stories and/or other news content data sources to select desired media content for creating a video newscast. The AI Avatar Creation subroutine 204 contains an Avatar Generation protocol 212 that generates an avatar with facial features and gestures for presenting the video newscast. The Voice Synthesis subroutine 206 contains a Text-to-Speech protocol 214 for deriving natural intonations, pauses, emotional tones, etc., for delivering news within the video newscast. Video Synchronization subroutine 208 contains a Voice & Animation Synchronization protocol 216 that coordinates the speaker characteristics output by the Voice Synthesis subroutine 206 with the digital avatar created by the AI Avatar Creation subroutine 204. The final product may be disseminated via an AI News Delivery subroutine 218.

Disclosed video newscast-generating systems and methods may employ an AI-driven story compilation and selection module that autonomously identifies and curates relevant news content for inclusion in a video newscast, be it a single video newscast package or an entire unified newscast program. An AI avatar creation module may employ voice synthesis software to create a lifelike digital avatar that delivers a news story within the curated video newscast with a realistic synthesized voice, e.g., to ensure a professional and engaging presentation. An automated video newscast formatting module may seamlessly integrate on-screen animations, graphics, superimposed text (“supers”), photos, video clips, etc., into the video newscast. This AI-driven system may help to ensure that the video output mimics the look and feel of a traditional newscast. Generated video content may be seamlessly hosted and displayed on a newspaper's website, mobile app, or connected TV app, e.g., to enhance accessibility for readers and viewers. The system may have a scalable architecture that is designed to accommodate multiple news organizations, social media platforms, microblogging services, digital magazines, etc., and vary system input/output based on varying content volumes and frequencies.

Technical capabilities for at least some of the disclosed systems and methods may include natural language processing that provides extraction, comprehension, and curation of digital content from text-based media. As a further option, advanced AI speech synthesis and avatar creation may generate natural and realistic speech for AI-generated avatars that deliver news content. Video editing and composition tools may automate the assembling of video newscasts with professional transitions, effects, and formatting. The system may also integrate web scraping techniques to collect news stories, headlines, images, clips, and/or other media from online sources, such as a news organization's website. Disclosed systems and methods may further provide seamless integration with existing website infrastructures to enable effortless publishing and hosting of video content while ensuring compatibility with standard web technologies.

Attendant advantages for at least some of the disclosed concepts include improvements to existing technology through increased automation and efficiency by minimizing manual effort and enabling news organizations to produce high-quality video content quickly and cost-effectively. Enhanced audience appeal may be provided through AI-generated video newscasts and standalone AI-hosted stories that deliver content in an engaging multimedia format, attracting and retaining viewers. A scalable solution may be provided that is capable of supporting multiple newspapers, regardless of their respective sizes and content volume. Professional aesthetics may also be provided by incorporating traditional broadcast elements (e.g., graphics, animations, voiceovers, etc.) to deliver a “polished” and “professional” TV-like newscast experience. Furthermore, increased accessibility and convenience may enable audiences to consume local news content through AI-driven video stories on digital platforms.

As an example of integrating herein-described concepts into a practical application, disclosed systems and methods may leverage cutting-edge technologies, including Natural Language Processing, AI-driven avatars with synthesized voices, and automated video composition tools, to transform text-based news stories and accompanying images into professional-grade video newscasts. The NLP engine may employ a named entity recognition (NER) and sentiment analysis routine to curate relevant content from digital platforms. AI avatars may be dynamically constructed and customized, e.g., in real-time, to deliver news stories with synchronized speech patterns and lifelike facial expressions. Automated video composition incorporates animations, graphics, photos, superimposed text, and transitions to emulate traditional television broadcasts, e.g., without the cost, time, and manual labor typically required by such traditional broadcasts. Designed for scalability and cost-efficiency, disclosed systems may altogether eliminate manual workflows while enabling local news organizations to produce high-quality multimedia content efficiently. By addressing longstanding challenges in newscast production logistics and cost barriers, disclosed features may provide a novel solution tailored specifically for modernizing local news delivery.

Key system features may include, singly or in any logical combination:
End-to-End Automation: the system may automate every step of newscast production, from content extraction to video distribution, eliminating the need for manual intervention or specialized technical expertise.
Content Extraction and Curation: the system may integrate with Content Management Systems (CMSs) and may use advanced NLP algorithms, including Named Entity Recognition (NER) and sentiment analysis, to autonomously extract and curate text-based articles, images, and multimedia elements from digital platforms or content management systems.
Sports Content Analysis and Presentation: the system may analyze the content and context of sports news and information, then customize the script to enable the news anchor to sound conversational and contextually aware.
AI News Delivery: the AI news delivery module may incorporate lifelike AI avatars with synthesized voices to anchor the newscasts and deliver curated news stories in a professional manner. The avatars may replicate human-like speech patterns and synchronized movements that create engaging presentations. The module may also support the option to produce videos in which news anchors are only heard accompanied by visuals, and the option to use voices without visuals to deliver news in podcast form.
Automated Video Composition: the system may ingest written content, e.g., from CMSs, APIs, RSS feeds, websites, or other sources, and incorporate multimedia, photos, video footage, graphics, and animation into polished video newscasts that achieve the visual impact of traditional television broadcasts.
Flexible Content Options: the system may support both full-length AI-hosted newscasts and standalone AI-hosted video stories derived from individual articles. Newscasts and stories may be automatically generated in any aspect ratio, such as 16:9 TV, 9:16 reels, etc.
Real-Time Updates: the system may periodically update video content to reflect breaking news or changes in stories, ensuring relevance and timeliness.
Scalability and Website Integration: the generated AI-hosted newscasts and standalone AI-hosted video stories may be seamlessly published on websites or digital platforms. The system may support varying content volumes and multiple organizations through scalable architecture.
Monetization Module: the monetization module may enable the automatic integration of targeted advertisements before, during, or after video newscasts. The automatic integration of advertising may be accompanied by the automatic integration of all accompanying elements, such as commercial break intros, outros, transitional animations, music bumpers, etc.

A representative practical application may include a local news organization using a herein-described newscast production system to automatically transform written news articles into a daily video newscast that is viewable on the organization's website. An NLP engine analyzes input from a variety of news stories and concomitantly makes context-aware story selections to feature in a newscast. Integrated NLP algorithms extract content and combine news stories into a seamless script optimized for the newscast. A generative adversarial network (GAN) automatically creates transitions, overlays, and effects that align with the pacing and structure of the newscast. One or more AI avatars are automated by the system to anchor the newscast with customized scripts and appropriate emotional expressions (e.g., seriousness). Output from the system automatically integrates with the news organization's website and/or mobile application (app) through which the newscast is distributed. The system may automatically update the newscast with live developments as new data becomes available, seamlessly integrating updates into the video stream. Targeted advertisements may be integrated in real-time before, during, and after the newscast, e.g., to generate revenue for the local news organization.

While illustrated and described herein for local news production, disclosed AI-driven systems for automating creation of digital media have significant potential for adaptation across various industries and integration into numerous applications beyond local news. By leveraging the seamless integration of one or more core technologies, such as Natural Language Processing, AI avatars, automated video composition tools, and real-time updates, the system may be customized to meet the unique needs of other sectors. Some non-limiting examples of how the system could be applied in different industries include: (1) corporate training videos; (2) educational modules; (3) marketing campaigns; (4) nonprofit advocacy campaigns; (5) event announcements and summaries; (6) government and public service announcements; (7) real estate virtual tours; (8) healthcare information distribution; (9) academic institution communications; and (10) entertainment.

Some of the features that may be implemented by disclosed systems and methods include, for example:

### 1. Advanced Natural Language Processing (NLP) Techniques

Context-Aware Story Selection: the system may employ NLP models utilizing sentiment analysis, entity recognition, and contextual understanding to prioritize and curate stories based on relevance, timeliness, and emotional impact. This may help to ensure that curated content aligns with audience preferences and newsworthiness.
Publisher Story Selection: publishers may tag news articles and multimedia content they want to prioritize, or they can override story selections made by the system. This may help to combine the efficiency of automated story selection with the flexibility of allowing delimited human intervention and control.
Real-Time Content Summarization: integrated NLP algorithms may be used to condense lengthy articles into concise summaries optimized for video scripts. The system may use the optimized summaries to tailor AI-generated content for video formats without human intervention.
Multilingual Support With Cultural Adaptation: the System May Translate News content into multiple languages while adapting cultural nuances to suit diverse audiences. Doing so may help to enhance accessibility and relevance for more viewers throughout the world.
   2. Automated Video Composition with Gans
Dynamic Transition Effects: AI-driven tools may be used to apply transitions, overlays, and effects automatically, e.g., based on the pacing and structure of the newscast. Doing so allows the system to produce polished video outputs that achieve the impact of traditional TV broadcasts without human intervention.
Generative Adversarial Networks (GANS) for Scene Creation: Gans May dynamically generate realistic background scenes or animations based on story context. For instance, a financial new video may feature real-time charts and graphs; a weather report video may include AI-generated weather maps, radar feeds, weather-related animations and overlays, etc.

### 3. Real-Time Updates and Iterative Processing

Breaking News Integration: the system may integrate with a Content Management System (CMS) that is used by publishers to continuously monitor digital platforms for breaking news and update video content dynamically. The system may keep local news organizations competitive by delivering timely updates.
Iterative Learning from Viewer Feedback: audience engagement metrics (e.g., watch time, click-through rates) may be used to refine future video compositions through reinforcement learning.
   4. Scalable Architecture with Cloud-Based Processing
Distributed Processing for Scalability: a cloud-based architecture may help to support simultaneous use by multiple news organizations without performance degradation. Features may include load balancing for high-volume processing, and a modular design enabling customization for different organizations'needs.

### 5. Integration of Interactive Features

Interactive Video Elements: clickable elements may be placed within videos (e.g., links to related articles or polls) enhance audience engagement. These elements are dynamically generated using NLP tagging systems. A sports story, for example, could include links to player statistics or game highlights.

### 6. Improved Multimedia Content Curation

Automated Multimedia Tagging: computer vision algorithms may analyze images or videos associated with articles and tag them with relevant metadata for seamless integration into newscasts. Combines NLP with computer vision to ensure multimedia elements align contextually with curated stories.

### 7. Personalization Features

Audience-Specific Newscasts: algorithms may personalize video content based on viewer preferences or geographic location. For example, a viewer in one city might see localized weather reports or community-specific stories.

### 8. Advanced Audio Processing

Voice Style Transfer: a voice synthesis module may mimic various accents, tones, and speaking styles based on audience demographics or regional preferences, dialects, or accents. Makes AI avatars sound relatable to local audiences.

### 9. AI-Powered Quality Control

Error Detection in Generated Content: AI models may review generated scripts and videos for factual accuracy, grammatical errors, or inconsistencies before publishing. Ensures high-quality output without manual intervention.

### 10. Advertising Integration

Revenue Generation from Advertising: a monetization module may enable integration of targeted advertisements before, during, or after AI-hosted newscasts and videos, creating new revenue streams for local news organizations.

For integration into the practical application of automated newscast video production, the AI-driven newscast production system 100 may take on a microservices computing architecture that contains multiple interoperable service engines, such as:
1. Backend Computing Service (BCS) engine: an on-demand backend application running on a remotely located cloud service for networking, processing, autoscaling, storage, etc. (e.g., AMAZON® WEB SERVICES (AWS®) Lambda serverless computing service);
2. Message Queueing Service (MQS): a message queuing service for asynchronous job processing, such as receiving, ordering, and storing data files on a first-in-first-out (FIFO) basis (e.g., AWS® Simple Queue Service (SQS®));
3. Memory Storage Service (MSS): a scalable, durable object storage service for storing large volumes of video/audio/image files (e.g., AWS® Simple Storage Service (S3®);
4. Artificial Intelligence Service (AIS): Large Language Module (LLM)-powered tools for video generation (e.g., Latent Diffusion Transformer (DiT) or Supervised Fine-Tuned (SFT) LLM for generating high-quality, realistic, and coherent videos); and
5. Video Processing Service (VPS): a video merging application for synchronously joining multiple video files (e.g., AWS® Elemental MediaConvert®); and
6. Task Scheduling Service (TSS): a serverless event bus application for scheduled tasks (e.g., AWS® EventBridge®).

Some non-limiting examples of practical applications for the foregoing automated newscast video production system includes:
1. Automated Production Without User Action: the system automatically

produces newscasts on preset schedules (e.g., hourly, daily, weekly, etc.) by importing articles from online news sites and converting each article into a story optimized to be read by a news anchor (article parsing), importing images/footage and generating story audio (story processing), organizing stories into an effective newscast rundown with opening and closing videos, greetings, commercials, transitions and graphics (rundown creation), generating complete video newscasts hosted by AI avatar anchors whose emotions match the tone of each story (newscast processing), and publishing the newscast videos online (video publishing).
2. Automated Production With Single Click by User: the system automatically produces a newscast by importing articles from online news sites and converts each article into a story optimized to be read by a news anchor (article parsing), importing images/footage and generating story audio (story processing), organizing stories into an effective newscast rundown with opening and closing videos, greetings, commercials, transitions and graphics (rundown creation), generating complete video newscasts hosted by AI avatar anchors whose emotions match the tone of each story (newscast processing), and publishing the newscast videos online (video publishing).
3. Automated Production after User Approves Content: the system automatically imports articles from online news sites and converts each article into a story optimized to be read by a news anchor (article parsing), imports images/footage and generates story audio (story processing), and organizes stories into an effective newscast rundown with opening and closing videos, greetings, commercials, transitions and graphics (rundown creation) for user approval, after which the system automatically generates a complete video newscast hosted by AI avatar anchors whose emotions match the tone of each story (newscast processing), and publishes the newscast video online (video publishing).
4. Automated Production after User Inputs Content: the user selects or provides relevant news data, along with related articles, photos, footage, etc. ; the content is organized using the system's intuitive interface, after which the system automatically generates a complete video newscast hosted by AI avatar anchors whose emotions match the tone of each story (newscast processing), and publishes the newscast video online (video publishing).

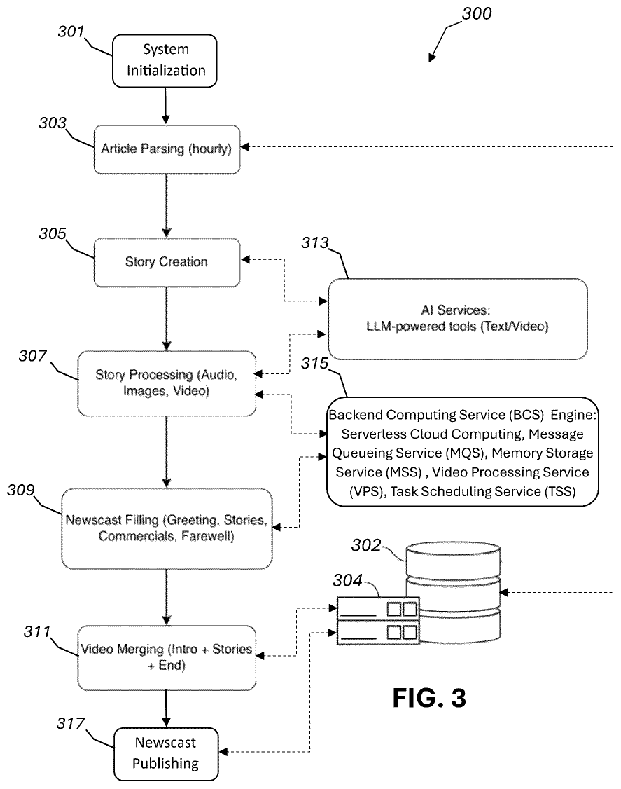

With reference next to the flowchart of FIG. 3, an improved method or control protocol for governing operation of a newscast production system, such as distributed computing newscast production system 100 of FIG. 1, for automating the production of video newscasts is generally shown at 300 in accordance with aspects of the present disclosure. Some or all of the operations illustrated in FIGS. 3-8 and described in further detail below may be representative of an algorithm that correspond(s) to non-transitory, processor-executable instructions that may be stored, for example, in main or auxiliary or remote memory (e.g., cloud service database 302 of FIG. 3). These instructions may be executed by a resident or remote microprocessor, control module, programmable logic device (PLD), central controller, integrated circuit (IC) device, or network of processors/controllers/modules/devices/etc. (e.g., server-class cloud computing terminal 304 of FIG. 3) to perform any or all of the above and below described functions associated with the disclosed concepts. It should be recognized that the order of execution of the illustrated operation blocks may be changed, additional operation blocks may be added, and some of the herein described operations may be modified, combined, or eliminated.

Method 300 begins at INITIALIZATION terminal block 301 of FIG. 3 with memory-stored, computer-readable instructions for initializing a main flow control protocol for a newscast production system. This routine may be initialized in real-time, near real-time, continuously, systematically, sporadically, and/or at predefined time intervals, for example, each ten (10) or sixty (60) minutes during routine operation of the system 100 of FIG. 1. As yet another option, terminal block 301 may initialize in response to a user command prompt (e.g., from a network-connected personal computing device of a system subscriber), a resident system controller prompt (e.g., from central computing terminal 304), or a broadcast prompt signal received from a remotely located data source (e.g., an automated breaking news alert received from a major global news agency). Upon completion of some or all of the control operations presented in FIGS. 3-8, method 300 may advance to PUBLISHING terminal block 317 and temporarily terminate or, optionally, may loop back to terminal block 301 and run in a continuous loop.

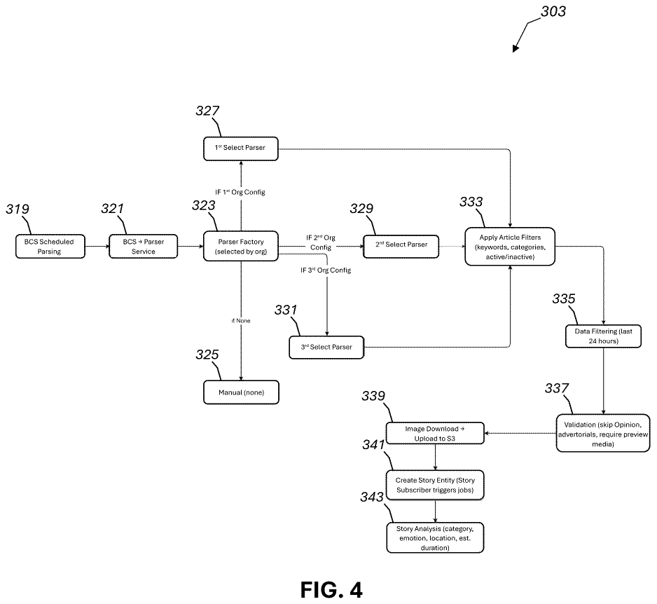

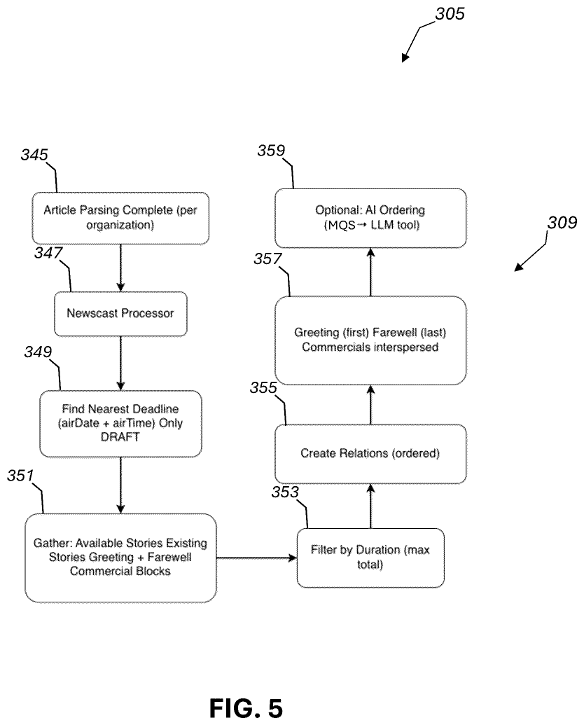

Advancing from terminal block 301 to ARTICLE PARSING engine 303 (FIG. 4), method 300 imports news content data from a dispersed array of distinct data sources. For instance, written content from multiple websites, content management systems, and/or syndication feeds is automatically imported, converted into news stories with metadata, optimized to be read by digital news anchors, and stored in the system's video library. Method 300 thereafter proceeds to STORY CREATION engine 305 (FIG. 5) and organizes the imported news content data into a set of discrete story rundowns that are stored in a system memory device. By way of non-limiting example, the STORY CREATION engine 305 may execute a rundown creation subroutine that automatically organizes stories into effective newscast or feature story rundowns, which may be supplemented with opening and closing video segments, greetings, commercials, transitions, graphics, etc. Rundown creation may be enabled by a set of LLM-powered tools within the AIS engine 313 of FIG. 3.

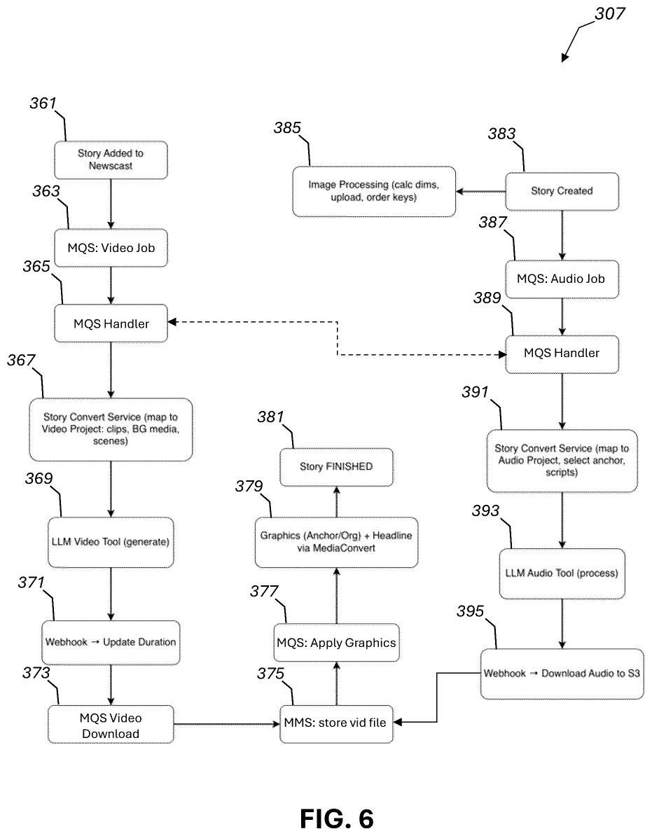

Upon completion of the rundown creation subroutine, method 300 of FIG. 3 may advance to STORY PROCESSING engine 307 (FIG. 6) to generate a distinct video newscast package for each story segment that corresponds to at least one of the story rundowns output from the STORY CREATION engine 305. For instance, story processing may include curating audio and video for each story, including an emotionally appropriate AI-avatar anchor that is generated using the LLM-powered tools of AIS engine 313. At the same time, images and video footage are processed for the story along with a set of graphics that are applied to the story, for example, that are generated by the BCS engine 315 of FIG. 3.

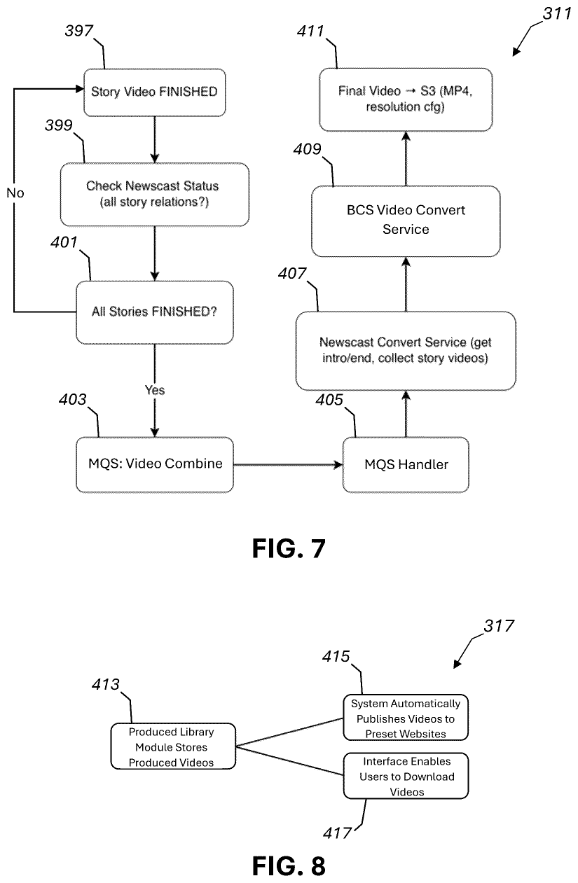

In conjunction with story processing, method 300 may proceed to NEWSCAST FILLING engine 309 (FIG. 5) to generate supplemental content for a final unified newscast program and VIDEO MERGING ENGINE 311 (FIG. 7) to merge select video newscast packages into the unified newscast program according to a predefined newscast rundown. By way of non-limiting example, the NEWSCAST FILLING engine 309 may execute a newscast filling subroutine to generate custom-tailored supplemental content for the newscast video, such as a newscast opening video, a newscast closing video, a newscast greeting, optional newscast commercials, story-to-story transitions, custom graphics, etc. VIDEO MERGING ENGINE 311 then merges the individual story videos and the supplemental content into a unified “complete” newscast video. Upon completion of the unified newscast program, method 300 moves to NEWSCAST PUBLISHING engine 317 (FIG. 8) and publishes the unified newscast program on a dispersed array of distinct websites. By way of example, the final newscast videos are posted to select subscriber websites and made available for viewing and download to select user accounts.

FIG. 4 illustrates a representative data-extraction control protocol for the ARTICLE PARSING engine 303 of the newscast production system and control method 300 of FIG. 3. In accord with the illustrated example, the ARTICLE PARSING engine 303 executes process block 319 to begin scheduled parsing, which may include determining whether or not a parsing trigger for importing content has occurred and, if so, responsively determining a parsing window during which the system is to import news content. For instance, the system's Task Scheduling Service may call up a rule set that dictates running to import content on a preset schedule, such as every half-hour, hour, half-day, day, etc. The system's Backend Computing Service may concurrently identify a preset window for parsing news-related data, such as the prior twenty (24) hours, as indicated at process block 321.

After initiating scheduled parsing at process block 319, the ARTICLE PARSING engine 303 executes a parser factory pattern subroutine at process block 323 to select an appropriate parser service. Process block 323 may include using a predefined parser factory pattern to select a suitable parser based, for example, on a respective configuration of the data source (e.g., “organization”) that is the origin of the news articles. Parser selection logic may include: (1) use a first parser (e.g., WordPress Parser) if the subject organization has a first configuration (e.g., WordPress source type); (2) use a second parser (e.g., BLOX Digital Parser) if the organization has a second configuration (e.g., BLOX Digital Content Management System (CMS) source type); (3) use a third parser (e.g., Really Simple Syndication (RSS) Parser) if the organization has a third configuration (e.g., an RSS feed URL); and (4) use default or manual parsing if organization adds stories manually. For a data source that adds stories manually, ARTICLE PARSING engine 303 may employ manual parsing or may altogether omit parsing, as indicated at process block 325. Alternatively, if the data source has a first organization configuration, a first selected parser is implemented at process block 327. Likewise, a second selected parser is implemented at process block 329 if the data source has a second organization configuration, whereas a third selected parser is implemented at process block 331 if the data source has a third organization configuration.

Once an appropriate parser is selected, ARTICLE PARSING engine 303 initiates article parsing at process block 333 of FIG. 4. By way of non-limiting example, article parsing may include the following steps for each organization that is a source of news-related data: (1) parser fetches articles or news related data from source (process block 333); (2) optional organization-level data filters are applied, such as excluding articles by keywords, categories, etc. (process block 333); (3) articles may also be filtered according to a preset date range (process block 335); (4) BCS may validate that the filtered articles are excluded, necessary images or videos are included, etc. (process block 337); (5) preview images are downloaded from the source and uploaded to the system's file storage (process block 339); and (6) story entities are created and saved to the database (process block 341). For story entity creation at process block 341, a story entity may be created from an imported article as follows: (i) Story Subscriber: triggers automatically; (ii) Audio Processing: MQS job sent to queue; (iii) Image Processing: MQS job sent to queue; and (iv) AI Analysis: story analyzed at process block 343 for: (a) category detection, (b) emotion detection (such as happy/neutral/serious/etc.), (c) location detection (such as local/national/international/etc.), and (d) estimated duration calculation.

In a non-limiting use case scenario, the newscast production system may implement a story library module that is configured as a persistent storage repository for story entities. A story entity may be typified as a data object that represents a story created by the system using content that was either automatically imported by the system or manually entered by a user. Story entities may be automatically incorporated into newscast entities, which are completed videos that each contain multi-story entities, or incorporated into feature story entities, which are completed videos that each contain a single-story entity. The story library may retain all story entities that were created within a specified timeframe (e.g., the last 30 days). Each story entity within the story library may display details such as: (1) zero or more reference links to newscast entities or feature story entities in which the story entity is utilized; (2) imported date of the original news article from which the story entity was created; and (3) metadata indicating the air date for the newscast in which the story entity was featured. The story library module may provide functionality for the utilization of story entities for purposes such as: (1) generating feature story entities derived from individual story entities; (2) generating newscast entities from multiple story entities; and (3) adding, removing, or editing the content of story entities.

For story entity structure and processing, each story entity may contain multiple elements, such as: (1) one or more digital image or video assets; (2) a headline text string; and (3) a story body text string. Story entities may be generated, for example, via automated content retrieval from configured content sources or via manual creation by users. The system may provide modification and deletion capabilities for individual story entities or bulk deletion of multiple selected story entities. Story entities retrieved from automated content sources that are deleted from the story library by users may be automatically regenerated during subsequent content retrieval cycles (e.g., executed at hourly intervals). Manually created story entities, when deleted, may be permanently removed from the system.

For a Text Processing Pipeline, the newscast production system may implement a dual-format text processing pipeline that utilizes artificial intelligence algorithms to create a long-form version of the story entity, e.g., for use in feature story entities, and a short-form version of the story entity, e.g., for use in newscast entities. To optimize story entity creation or retrieval to be read by an AI avatar anchor, the story body text may undergo select transformations such as:
1. Long-Form Version Generation—the AI processing module applies text normalization rules to improve AI avatar pronunciation, such as: (1) rewriting numerical expressions in conversational terms; (2) expansion of abbreviations; (3) rewriting sports scores and results in conversational terms; and (4) applying additional normalization rules to generate reader-friendly text suitable for an AI avatar anchor. This long-form version may be available for the creation of feature story entities and preserves the complete content of the original article that was automatically imported or manually added by a user.
2. Categorization—the AI processing module may classify each story entity by relevant details such as content type (e.g., “general news” or “sports”) or geographic scope (e.g., “local”, “national” or “international”).
3. Short-Form Version Generation—the AI processing module may generate a shortened version of the story text that preserves primary narrative elements and essential information while reducing overall length. This short-form version may be utilized for newscast video production where time constraints require brevity.

FIG. 5 illustrates a representative rundown-creation control protocol for the STORY CREATION engine 305 of FIG. 3. For at lease some intended applications, there may be two primary types of story rundowns, a full newscast rundown and a feature story rundown. A full newscast rundown may be automatically produced on a preset schedule, may contain multiple stories, may include start (hello) and end (goodbye) greetings from a system-generated anchor, and may include one or more commercial advertisements. In contrast, a feature story may contain a single story, may contain one or more stories that are manually selected or added by a user, may or may not automatically include greetings from a digital anchor, and may or may not include commercial advertisements.

Rundown creation may be triggered upon completion of article parsing, as indicated at process block 345 of FIG. 3. The STORY CREATION engine 305 thereafter initiates a newscast processor at process block 347 and concomitantly identifies a nearest-in-time newscast deadline for a select organization, including determining an air date and an airtime for that deadline at process block 349. At this juncture, the newscast processor may only process a DRAFT status for each newscast. After pinpointing the nearest deadline at process block 349, the newscast processor may first identify story segments with similar air dates and airtimes, and then order the story segments, e.g., first by air date and then by airtime. At process block 351, the STORY CREATION engine 305 may execute story selection logic to gather available story segments based on a predefined set of selection criteria. The selection criteria may include: (1) the story belongs to the organization, (2) the story is not deleted, (3) the story is not already in a newscast (or deleted from a newscast), and (4) the story has a “valid” status.

Advancing from process block 351 to process block 353 of FIG. 5, the STORY CREATION engine 305 may filter the gathered story segments based on a predefined duration threshold (e.g., must be less than or equal to a preset maximum total duration). Duration filtering may include calculating a current newscast duration and filtering story segments to fit within this newscast duration, e.g., using an estimated or actual duration for each story segment. After ordering and filtering the story segments, STORY CREATION engine 305 may create story relations for the filtered story segments at process block 355.

At process block 357, NEWSCAST FILLING engine 309 may generate a first (start/greeting) segment and a last (end/farewell) segment and, optionally, may supplement the video segments with a set of interspersed commercials. An anchor opening (start/greeting) segment may include an introduction, may be an AI-generated customized greeting or a memory-stored default greeting, and may be placed first in the newscast program. Likewise, an anchor closing (end/farewell) segment may include a farewell, may be an AI-generated customized farewell or a memory-stored default farewell, and may be placed last in newscast. At the same time, one or more commercial segments may be incorporated into the newscast, for example, inserted between stories based on configuration criteria. The commercial segments may include commercial breaks (e.g., regular advertisement BLOX), stay-tuned breaks (e.g., transition break), sports breaks (e.g., sports-related break), or news breaks (e.g., news-related break).

STORY CREATION engine 305 may thereafter execute process block 359 and employ an AI-driven message queueing service (e.g., SQS®) to order the story, anchor opening, anchor closing, and commercial segments. As part of a newscast rundown relations subroutine, the segments may be ordered according to a relation order: (1)

greeting segment, (2) story segments (in order), (3) commercial segments (interspersed), and (4) farewell segment. In this regard, the individual segments may be assigned a corresponding relation type, such as regular story relation, direct video relation, or commercial block relation. AI ordering of content in a newscast rundown, which may be enabled/disabled by a user, may include the MQS sending a job to an ordering queue, an LLM-powered tool analyzing content of the job and suggesting optimal order, and updating the order based on the segment relations.

For rundown creation, a control room module with a scheduling interface may create and schedule rundowns at predefined intervals. The control room module may provide a centralized dashboard for: (1) displaying lists of newscast entities and feature story entities; (2) performing newscast scheduling operations; (3) and providing navigation to related system modules. The display interface may contain two discrete sections: (1) a newscast entity list view; (2) a feature story entity list view. Users toggle between views using a display mode selector control. The newscast scheduling system may provide functionality for automated newscast episode generation based on a set of user-defined parameters: (1) date range-a start date and an end date defining the temporal span for newscast episode generation; (2) air time-the scheduled broadcast time applied to each episode within the date range; (3) publication frequency-episode generation frequency (e.g., selectable from daily, weekly, monthly, or custom interval patterns); and configuration options-default settings including: (a) synthetic anchor avatar utilization flag, (b) default greeting story text template, and (c) default farewell story text template.

Upon schedule creation, the system may generate individual newscast entity instances for each date within the specified range according to a periodicity parameter.

For each newscast entity, a newscast list display may present: (1) air date, (2) episode identifier, (3) current status, and (4) estimated duration in minutes. The interface may provide a set of individual deletion controls for each newscast entity and bulk deletion functionality for multiple selected entities. Upon selection of a newscast entity from a control room list, the system may present a produce newscast module that displays all constituent components that have been automatically assembled into a rundown and provides interactive manipulation controls that allow a user to override the automatic sections made by the system. For fixed-position stories, each newscast may include (by default): (1) a greeting story segment positioned at the beginning of the story sequence; (2) a farewell story segment positioned at the end of the story sequence. These fixed position stories maintain their respective positions independent of other content manipulations.

For dynamic story content, story entities may be automatically populated by an automatic story population algorithm or may be manually added from the story library. The system may implement a drag-and-drop interface mechanism that enables users to reposition story segments within the newscast sequence by: (1) selecting a story segment through a user input device; (2) dragging the selected story segment to a desired position within the newscast sequence; and (3) releasing the story segment to commit the new position. Upon each repositioning operation, the system may immediately persist the modified story sequence configuration to storage, automatically updating the newscast entity status from Draft to Draft Saved if the status transition conditions are satisfied. For custom story content, user-generated story segments (or “entities”) may be created within the newscast composition interface through dedicated story creation controls. For asset entities, one or more video break segments may be inserted at specified positions within the story sequence through user selection and positioning operations.

Display controls of the scheduling interface may include an EXPAND ALL button control that simultaneously transitions all story entity display elements from a collapsed state to an expanded state. Upon activation of the EXPAND ALL control, each story entity display may reveal all associated image assets linked to the story entity and the complete story body text in the format designated for newscast production (short-form version). This bulk expansion operation may enable rapid visual review of all newscast content without requiring individual expansion of each story entity. The scheduling interface may also provide an ASPECT RATIO TOGGLE control (designated as ‘vertical’) that configures the video output format parameters for the newscast entity. The TOGGLE control may operate in two states: (1) a deactivated state wherein the video generation pipeline produces output with a 16:9 aspect ratio optimized for horizontal display orientation; and (2) an activated state wherein the video generation pipeline produces output with a 9:16 aspect ratio optimized for vertical display orientation (e.g., on mobile devices and portrait-mode display systems). The selected aspect ratio may persist as an attribute of the newscast entity and may govern all subsequent video rendering operations.

A newscast composition interface may implement in-context editing functionality that enables direct modification of story entity content within a newscast sequence without requiring navigation to separate editing interfaces or modules. The editing workflow may include: (1) user selection of a story entity currently positioned within the newscast sequence; (2) invocation of an edit mode through a designated edit control associated with the selected story entity; (3) presentation of editable fields for story attributes including headline text, body text, and image asset associations; (4) user modification of one or more story attributes; and (5) commitment of modifications through a save operation. For the save operation, the system may update the story entity data and immediately reflect the modified content in the newscast composition display.

The newscast production system may maintain a library of available stories with story entities that satisfy a set of predefined story library criteria, such as: (1) not currently assigned to any newscast entity; and (2) creation timestamp within fourteen (14) days of current date. In this example, a user can: (1) add story entities from the available stories library to the current newscast; (2) edit story entity content within the available stories library; and (3) remove story entities from the available stories library, transferring them to story library storage only. Removed story entities may remain in the story library and, if desired, may be manually restored to the available stories library through story library operations.

Continuing with the above example, the newscast production system may implement an automatic story population algorithm that operates to populate story entities into newscast entities. By way of example, and not limitation, the system may retrieve new article content from organization-specific content sources, such as URLs or Really Simple Syndication (RSS) feeds, at regular intervals (e.g., hourly). The system may then convert retrieved content into story entities with extracted images, headlines, body text, etc. In addition, the system may identify story entities that have not been previously utilized in any newscast and may automatically assign them to newscast entities in “draft” status based on air date proximity.

The newscast production system may employ a temporal constraint system that maintains temporal attributes for the newscast entities. Each newscast entity may maintain at least two temporal attributes, which are time related data values: (1) Air Date-the scheduled date and time by which the newscast video must be fully produced and available in the produced library; and (2) Production Deadline-the date and time after which: (a) no additional story entities can be automatically assigned to the newscast, (b) manual story additions are disabled, and (c) the newscast is automatically submitted to the video generation pipeline with its current configuration.

For Duration Management, the newscast production system may calculate and display a total newscast duration based on: (1) estimated narration time for each story

entity; and (2) duration of asset video segments. While a default target duration (e.g., 30 minutes) may be suggested, the system may permit newscast configurations exceeding this duration without enforcing hard constraints. For feature story entity structure, a feature story entity may represent an extended-format video production that is derived from a long-form version of a single-story entity's text. Rundowns for feature story entities may support integration of additional custom story content as specified by users.

FIG. 6 illustrates a representative story-creation control protocol for the STORY PROCESSING engine 307 of FIG. 3. At process block 361, the STORY PROCESSING engine 307 adds a select story segment to a newscast program. Once added, the STORY PROCESSING engine 307 executes process block 363 and the MQS initiates a new video job. The newly received video job is passed to an MQS handler at process block 365 of FIG. 6. In accord with these examples, video processing may include processing one or more images and/or videos pertaining to a select news story, calculating respective dimensions for these images/videos, uploading the images/videos to file storage, and creating order keys for the stored image/video entities.

At process block 367, the MQS handler then coordinates with a story conversion service to convert the video newscast packages of the selected story segments into a unified newscast program stored in system memory. The story conversion service may map each story segment to an LLM-powered video generation project format. A script may be read by one or more AI-driven avatar anchors along with background images/videos in coordination with select scene configuration guidelines. The mapped and scripted videos are then sent to an LLM-powered video tool generator at process block 369. The LLM-powered video generator may process the individual video segments to generate respective videos containing an AI-avatar anchor.

Advancing from process block 369 to process block 371 of FIG. 6, the STORY PROCESSING engine 307 executes a webhook subroutine; the LLM-powered video generator calls a webhook when a video is ready, extracts duration data from the project, and then updates the story duration to match the generated video. At process block 373, a Memory Storage Service, such as Simple Queue Service (SQS®), then downloads the updated video job by sending the job to a download queue; the video is then downloaded from the LLM-powered video generator to file storage at process block 375. After downloading the video file, an MQS graphics application sends the job to a video graphics queue at process block 377. At this juncture, the system selects graphic assets, such as organization graphics, anchor title graphics, story-related graphics, etc. Graphic overlays are then applied, for example, using an appropriate Video Processing Service (e.g., AWS MediaConvert) at process block 379. The “final” newscast entity video is then saved to file storage at process block 381.

Prior to, contemporaneous with, or after the video generation operations of process blocks 361-381 of FIG. 6, the STORY PROCESSING engine 307 creates a select story segment at process block 383. Story creation may include the processing of one or more images associated with the newly created story, such as dimension calculations, uploading image files, ordering image keys, etc., at process block 385. Once created, the STORY PROCESSING engine 307 executes process block 387 whereat the MQS initiates a new audio job. The newly received audio job is then passed to the MQS handler at process block 389 of FIG. 6. At process block 391, the story conversion service may map each story segment to an LLM-powered audio generation project format, select a digital anchor based on related emotion and category criteria, create a script with anchor clips for the story segment, and send the script with anchor clips to an LLM-audio generator. Each mapped video is then sent to an LLM-powered audio tool generator at process block 393. The LLM-powered audio generator may process the individual video segments to generate audio narration for each AI-avatar anchor.

Advancing from process block 393 to process block 395, the webhook subroutine determines when the audio file for a story segment is ready. MMS may then download and store the associated audio file. For story status tracking, the system may use story process entities to track each processing step: (1) audio generation in LLM-powered audio generator, (2) audio download from LLM-powered audio generator, (3) video generation in LLM-powered video generator, (4) video download from LLM-powered video generator, and (5) application of graphics overlays. Each story entity included in a newscast rundown may be processed into an individual story video. The individual story videos may be combined into a newscast video during newscast processing.

Presented in FIG. 7 is a representative newscast-processing control protocol for the VIDEO MERGING ENGINE 311 of FIG. 3. Newscast processing may be triggered in response to each individual story segment video being completed, as indicated at process block 397. To this end, a story completion check may include: (1) a trigger event confirming story processing is complete (process block 397); (2) a status check-confirming all story relations in newscast and verifying all stories have generated media content (process block 399); and (3) an all finished check-confirming all story processing is complete, marking the newscast video process as finished, and sending the MQS job to a video combine queue (process block 401).

After finishing the story completion check, the VIDEO MERGING ENGINE 311 may proceed to process block 403 of FIG. 7 and employ a Message Queueing Service (e.g., SQS®) to merge the video newscast packages of the story segments into a unified newscast program. Video combining may begin with the MQS Handler accessing the video combine queue (process block 403) and concurrently processing the requested video combining job (process block 405). Thereafter advancing to process block 407, the VIDEO MERGING ENGINE 311 may employ a BCS newscast conversion service to gather organization assets, such as the opening and closing video segments, gather all story video files earmarked for the newscast, and build a corresponding video list.

At process block 409, the VIDEO MERGING ENGINE 311 employs a BCS video conversion service to create a media convert job, merge the videos segments—in sequence—into a solitary newscast program file, and output the program file to MSS for file storage. Once completed, a status update may be performed to confirm the job is stored, the file name contains a file URL for the final video, and the process status is tracked. At process block 411, the newscast program video's final structure may be sequenced as follows: (1) Opening Video—organization-specific intro (from assets); (2) Story Videos—all story videos in newscast order; and (3) Closing Video—organization-specific outro (from assets). The video may be output in a predetermined format (e.g., MP 4) with a predetermined resolution (e.g., 1080p (Full HD) or 4k (UHD), which may be configurable, and may be located in a housed in resident or remote file storage. For process status tracking, a newscast may use entities to track the video merging process and, when applicable, the audio merging process.

Newscast processing may result in the creation of a newscast entity with a corresponding newscast entity structure. In this example, the newscast entity is comprised of an ordered sequence of content items including a set of story entities and zero or more asset entities that represent video break segments. The system may automate generation of a final newscast video output that presents story content in a structured narrative format that is analogous to traditional broadcast news programs. For the newscast status workflow, the newscast production system may store newscast entities in applicable states such as:
1. Draft Status—indicates a newly created newscast entity is eligible for automatic population with story entities from the story library;
2. Draft Saved Status—indicates user-initiated preservation of a newscast configuration, disabling automatic story population while permitting manual story additions;
3. In Production Status—indicates that the newscast entity has been submitted to the video generation pipeline. Newscast entities in this state are immutable and cannot be modified. A copy operation is available to generate a duplicate newscast entity with Draft status;
4. Done Status—-indicates successful completion of video generation with the resulting video file stored in a produced library module. Newscast entities in this state remain immutable and support copy operations.

Turning next to FIG. 8, there is shown a representative video publishing and asset management control protocol for the NEWSCAST PUBLISHING engine 317 of FIG. 3. At process block 413, for example, a produced library module acts as a persistent storage repository for completed video output files that are generated through the newscast and feature story production pipelines. Moving to process block 415, the NEWSCAST PUBLISHING engine 317 may employ a video publishing & asset management service to publish the final newscast videos and feature story videos to predetermined online destinations.

At process block 417, an adaptive and interactive user interface enables users to select and, if desired, modify certain aspects of the videos housed in file storage. The produced library interface may contain two discrete display sections that are selectable through a toggle control: (1) a newscast video list view; and (2) a feature story video list view. For each video entity stored in the produced library, the interface may display the following: (1) the generated video content with integrated playback controls; (2) an episode identifier corresponding to the source newscast or feature story entity; (3) the air date attribute from the source entity; (4) a download control configured to initiate transfer of the video file to a user's personal computing device or local storage device; and (5) a deletion control configured to remove the video entity from the produced library storage. The playback controls enable users to view the complete newscast/feature video content within the interface without requiring external video player applications.

An Asset Management Module may be implemented by the newscast production system to organize and store video break segments utilized in newscast production. The Asset Management Module may categorize asset entities into predefined break types including: (1) commercial break assets; (2) news break assets; (3) sports break assets; and (4) stay tuned break assets. For the asset entity structure, each asset entity may comprise one or more video file components with the following constraints: (1) the cumulative duration of all video file components within a single asset entity does not exceed 60 seconds; and (2) each video file component conforms to system-supported video format specifications. The asset management module may maintain a shared available videos repository that is accessible across some/all break type categories. The repository may provide functionality for the selection and assignment of existing video files to asset entities of any break type, and for uploading new video files subject to a file size constraint not exceeding 500 megabytes per file. The interface may implement a section toggle control that enables users to switch between the categorized asset entity view organized by break type and the available videos repository view displaying all uploaded video files available for assignment to asset entities.

Aspects of this disclosure may be implemented, in some embodiments, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software, or a combination thereof, in a computer system or other processing system.

Any of the methods described herein may include machine readable instructions for execution by: (a) a processor, (b) a controller, and/or (c) any other suitable processing device. Any algorithm, software, control logic, protocol, or method disclosed herein may be embodied as software stored on a tangible medium such as, for example, a flash memory, a solid-state drive (SSD) memory, a hard-disk drive (HDD) memory, a CD-ROM, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms may be described with reference to flowcharts and/or workflow diagrams depicted herein, many other methods for implementing the example machine-readable instructions may alternatively be used.

Additional features of this disclosure are reflected in the following clauses:
Clause 1: a system for automating creation of a video newscast, the system comprising: an artificial intelligence (AI) engine configured to autonomously extract digital content from a digital platform and/or a content management system; an automated video composition tool configured to integrate one or more animations, one or more digital graphics, one or more photos, one or more videos, one or more superimposed texts, and/or one or more transitions into a professional-grade video newscast; and a publishing module configured to seamlessly integrate and distribute video newscasts on one or more websites or one or more digital platforms.
Clause 2: the system of clause 1, further comprising a real-time update module configured to dynamically modify video content to reflect breaking news or recent story changes.
Clause 3: the system of clauses 1 or 2, further comprising a monetization module configured to integrate one or more targeted advertisements before, during, or after the video newscast.
Clause 4: the system of any one of clauses 1 through 3, wherein the extracted digital content includes one or more text-based articles, one or more digital images, and/or one or more multimedia elements.
Clause 5: the system of any one of clauses 1 through 4, wherein the AI engine includes a set of advanced natural language processing (NLP) capabilities for context-aware story selection based on relevance, timeliness, and emotional impact.
Clause 6: the system of any one of clauses 1 through 5, wherein the AI engine includes one or more algorithms for real-time content summarization to condense lengthy articles into concise video scripts.
Clause 7: the system of any one of clauses 1 through 6, further comprising an AI-driven avatar creation engine including a synthesized voice capability module configured to generate curated content as a video presentation featuring a digital avatar with a synchronized speech pattern and one or more lifelike facial expressions.
Clause 8: the system of clause 7, wherein the digital avatar is configured to express dynamic emotional responses, including excitement and/or seriousness, based on a tone of a news story.
Clause 9: the system of clause 7, wherein the digital avatar is configured to synchronize speech with facial movements using viseme-based lip-syncing techniques.
Clause 10: the system of any one of clauses 1 through 9, wherein the automated video composition tool employs a generative adversarial network (GAN) to dynamically generate a realistic background scene and/or an animation tailored to a context of a news story, and applies an AI-driven transition effect and overlay based on a pacing and structure of the video newscast.
Clause 11: the system of any one of clauses 1 through 10, wherein the real-time update module integrates with a content management system (CMS) to actively monitor breaking news and dynamically update video content.
Clause 12: the system of any one of clauses 1 through 11, wherein the automated video composition tool is further configured to automatically convert an individual article into a standalone AI-hosted video story optimized for social media sharing.
Clause 13: the system of any one of clauses 1 through 12, further comprising an AI-powered quality control module configured to review scripts and videos for factual accuracy, grammatical errors, and/or inconsistencies.
Clause 14: the system of clause 3, wherein the monetization module is further configured to dynamically integrate targeted advertisements into video newscasts based on audience engagement metrics, including watch time, click-through rates, and viewer preferences.
Clause 15: the system of clause 3, wherein the monetization module is further configured to employ a geographic targeting routine to derive region-specific advertisements within a video newscast and tailor content of the video newscast to a local audience.
Clause 16: the system of clause 3, wherein the monetization module is further configured to execute real-time data analysis to optimize a placement and a timing of advertisements within a video newscast to maximize viewer retention and engagement.
Clause 17: the system of any one of clauses 1 through 16, further comprising an advertising recommendation engine configured to use a natural language processing (NLP) routine and a machine learning algorithm to match an advertisement with a curated news story based on contextual relevance.
Clause 18: the system of clause 3, wherein the monetization module is further configured to support an interactive advertisement embedded within a video newscast to allow a viewer to click on a link or participate in a poll directly from the video newscast.
Clause 19: the system of clause 3, wherein the monetization module is further configured to integrate with an external advertising platform to automate bidding for ad slots in real time.
Clause 20: a method for automating production of a video newscast, the method comprising: extracting a news story and a multimedia element from a digital platform using a natural language processing (NLP) module including a named entity recognition (NER) procedure and a sentiment analysis; incorporating a digital avatar with a synthesized voice into the extracted news story to produce a curated news story; formatting the curated news story into a formatted video newscast by incorporating animations, graphics, photos, superimposed text, and transitions; publishing the formatted video newscast on a digital platform; enabling a real-time update to the published video newscast to reflect breaking news or story change; and personalizing video content based on viewer preferences or geographic location.
Clause 21: the method of clause 20, further comprising translating the curated news story into one or more secondary languages while adapting cultural nuances using a multilingual NLP model.
Clause 22: the method of clauses 20 or 21, further comprising incorporating one or more audience engagement metrics, including a watch time and a click-through rate, to iteratively refine a future video composition through reinforcement learning.
Clause 23: the method of any one of clauses 20 through 22, further comprising integrating one or more targeted advertisements before, during, and/or after the video newscast as a monetization strategy for local news organizations.
Clause 24: the method of any one of clauses 20 through 23, further comprising dynamically inserting a pre-roll advertisement, a mid-roll advertisement, and/or a post-roll advertisement into the newscast based on audience segmentation and behavioral analytics.
Clause 25: the method of any one of clauses 20 through 24, further comprising generating a personalized advertisement for an individual viewer using AI-driven analysis of demographic data, viewing history, and/or geographic location.
Clause 26: the method of any one of clauses 20 through 25, further comprising iteratively improving an advertisement placement strategy based on viewer feedback and engagement data using a reinforcement learning algorithm.
Clause 27: a scalable system for automating multimedia production of a video newscast, the scalable system comprising: a cloud-based architecture configured to support distributed processing for simultaneous use by multiple organizations with varying content volumes; a personalization module configured to tailor video content of the video newscast based on one or more viewer preferences and/or a geographic location; and an interactive features module configured to embed within the video newscast one or more clickable links to related articles or polls dynamically generated using a Natural Language Processing (NLP) tagging system.
Clause 28: the scalable system of clause 27, wherein the interactive features module is further configured to embed within the video newscast one or more links to player statistics or game highlights for sports stories and/or polls or surveys to enhance audience engagement.
Clause 29: the scalable system of clauses 27 or 28, further comprising a voice synthesis module configured to mimic accents, tones, and/or speaking styles based on an audience demographic or a regional preference.
Clause 30: the scalable system of any one of clauses 27 through 29, further comprising a load balancing mechanism configured to ensure high-volume processing without performance degradation.
Clause 31: the scalable system of any one of clauses 27 through 30, further comprising a monetization module configured to enable a news organization to customize an advertisement placement within the video newscast while sharing a centralized AI-driven advertising platform.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A method of controlling a newscast production system for automating creation of a video newscast, the method comprising:
importing, via an article parsing engine of the newscast production system over a distributed computing network, news content data from a dispersed array of distinct data sources;
organizing, via a story creation engine of the newscast production system, the imported news content data into multiple story rundowns stored in a system memory device;
generating, via a story processing engine of the newscast production system using an Artificial Narrow Intelligence (ANI) module, a respective video newscast package narrated by a digital avatar anchor for each of multiple story segments correlated with the story rundowns;
merging, via a newscast processing engine of the newscast production system according to a predefined newscast rundown, the video newscast packages of the story segments into a unified newscast program stored in the system memory device; and
publishing, via a newscast publishing engine of the newscast production system over the distributed computing network, the unified newscast program on a dispersed array of distinct websites.

2. The method of claim 1, wherein importing the news content includes:
determining when an import content trigger has occurred; and
determining, in response to the import content trigger occurring, a preset parsing window, wherein importing the news content is restricted to the preset parsing window.

3. The method of claim 1, wherein importing the news content includes:
retrieving the news content data from the dispersed array of distinct data sources;
filtering the retrieved news content data;
validating the filtered news content data; and
downloading image previews for the validated news content data.

4. The method of claim 1, wherein organizing the imported news content data includes categorizing the story rundowns into preset newscast rundown types including an automatic newscast rundown and a feature story rundown, the automatic newscast rundown automating a schedule and content for the unified newscast program, and the feature story rundown including manual selection of the schedule and content for a feature story video.

5. The method of claim 4, wherein organizing the imported news content data includes:
determining a nearest newscast deadline including an air date and an airtime; and
ordering the story segments by the air date and the airtime.

6. The method of claim 5, wherein organizing the imported news content data further includes:
determining a criteria ruleset for the video newscast package;
calculating a current newscast duration for the video newscast package; and
selecting a subset of the ordered story rundowns based on the criteria ruleset and the current newscast duration for the video newscast package.

7. The method of claim 1, wherein generating the respective video newscast package for each of the story segments of the story rundowns includes:
mapping text within the correlated story rundowns to the story segment using a Large Language Model (LLM)-powered audio generation project format;
selecting the digital avatar anchor based on an emotion criteria and/or a category criteria;
composing an anchor script with anchor clips for the digital avatar anchor; and
generating, using an LLM-audio generator, an anchor audio file for the digital avatar anchor based on the anchor script.

8. The method of claim 7, wherein generating the respective video newscast package for each of the story segments of the story rundowns further includes:
processing text data and image data within the story rundown correlated to the story segment;
calculating image and video dimensions for the story segment;
creating image/video entities with order keys for the story segment; and
storing the processed text data and image data, calculated image and video dimensions, and the image/video entities with order keys to a storage file stored in the system memory device.

9. The method of claim 8, wherein generating the respective video newscast package for each of the story segments of the story rundowns further includes:
mapping images within the correlated story rundowns to the story segment using a Large Language Model (LLM)-powered video generation project format;
generating a scene configuration and a background image/video content for the video newscast package;
composing an anchor animation sequence for the digital avatar anchor; and
generating an anchor video file for the digital avatar anchor using an LLM-video generator.

10. The method of claim 1, wherein merging the video newscast packages into the unified newscast program includes:
determining when the respective video newscast packages for the story segments allocated by the predefined newscast rundown to the unified newscast program are finished;
sequencing the finished video newscast packages into a newscast video series in accordance with a newscast sequence set forth in the predefined newscast rundown; and
uniting the sequenced video newscast packages into a single video file.

11. The method of claim 10, wherein merging the video newscast packages into the unified newscast program further includes:
generating an opening video segment and a closing video segment customized to the unified newscast program; and
combining the opening and closing video segments into the newscast video series united into the single video file.

12. The method of claim 1, wherein publishing the unified newscast program includes:
creating an episode identifier including a newscast source entity or a feature story entity for the unified newscast program;
creating an air date attribute for the unified newscast program; and
assigning the episode identifier and the air date attribute to the unified newscast program stored in the system memory device.

13. The method of claim 12, wherein publishing the unified newscast program includes:
adding a video library interface with a set of playback controls for selectively displaying the unified newscast program on the each of the distinct websites; and
adding a download control to the video library interface for initiating transfer of the unified newscast program to a local storage device of a user.

14. A newscast production system for automating production of a video newscast, the newscast production system comprising:
an article parsing engine communicatively connected to a distributed computing network and programmed to import news content data from a dispersed array of distinct data sources;
a story creation engine communicatively connected to the article parsing engine and programmed to organize the imported news content data into multiple story rundowns stored in a system memory device;
a story processing engine communicatively connected to the story creation engine and programmed to generate, using an Artificial Narrow Intelligence (ANI) module, a respective video newscast package narrated by a digital avatar anchor for each of multiple story segments correlated with the story rundowns;
a newscast processing engine communicatively connected to the story processing engine and programmed to merge, according to a predefined newscast rundown, the video newscast packages of the story segments into a unified newscast program stored in the system memory device; and
a newscast publishing engine communicatively connected to the newscast processing engine and programmed to publish, over the distributed computing network, the unified newscast program on a dispersed array of distinct websites.

15. The newscast production system of claim 14, wherein the importing of the news content by the article parsing engine includes:
determining when an import content trigger has occurred; and
determining, in response to the import content trigger occurring, a preset parsing window, wherein importing the new content is restricted to the preset parsing window.

16. The newscast production system of claim 14, wherein the importing of the news content by the article parsing engine includes:
retrieving the news content data from the dispersed array of distinct data sources;
filtering the retrieved news content data;
validating the filtered news content data; and
downloading image previews for the validated news content data.

17. The newscast production system of claim 14, wherein the organizing of the imported news content data by the story creation engine includes:
determining a nearest newscast deadline including an air date and an airtime; and
ordering the story segments by the air date and then the airtime.

18. The newscast production system of claim 17, wherein the organizing of the imported news content data by the story creation engine includes:
determining a criteria ruleset for the video newscast package;
calculating a current newscast duration for the video newscast package; and
selecting a subset of the ordered story rundowns based on the criteria ruleset and the current newscast duration for the video newscast package.

19. The newscast production system of claim 14, wherein the generating of each of the respective video newscast packages by the story processing engine includes:
mapping text within the correlated story rundowns to the story segment using a Large Language Model (LLM)-powered audio generation project format;
selecting the digital avatar anchor based on an emotion criteria and/or a category criteria;
composing an anchor script with anchor clips for the digital avatar anchor; and
generating an anchor audio file for the digital avatar anchor using an LLM-audio generator.

20. The newscast production system of claim 19, wherein the generating of each of the respective video newscast packages by the story processing engine includes:
mapping images within the correlated story rundowns to the story segment using a Large Language Model (LLM)-powered video generation project format;
generating a scene configuration and a background image/video content for the video newscast package;
composing an anchor animation sequence for the digital avatar anchor; and
generating an anchor video file for the digital avatar anchor using an LLM-video generator.
